(19) United States
(12) Patent Application Publication
(10) Pub. No.: US 2016/0012490 A1
(43) Pub. Date: Jan. 14, 2016

(54) COMPUTER IMPLEMENTED SYSTEM AND METHOD FOR OPTIMIZING PROMOTIONAL OFFERS

(71) Applicant: Stephen J. Brown, Woodside, CA (US)

(72) Inventor: Stephen J. Brown, Woodside, CA (US)

(73) Assignee: INVENT.LY LLC, Woodside, CA (US)

(21) Appl. No.: 14/329,911

(22) Filed: Jul. 12, 2014

(51) Int. Cl. G06Q 30/02; G06Q 50/00

(52) U.S. Cl. CPC G06Q 30/0269; G06Q 30/0261; G06Q 30/0276; G06Q 50/01

(57) ABSTRACT

A system and method for customizing promotional offers to be made available to an affinity group. The system monitors the activities of a member of an affinity group (user) on a social networking portal, and identifies the actions and the behavior of the user in respect of at least one promotional offer made available to him on the social networking portal. The system further identifies at least one promotional offer suitable for the member (user) of the affinity group, based on the monitored actions and behavior of the member of the affinity group. Further, the system also customizes the identified promotional offer in order to render it suitable for the members of the affinity group.

### DEFINITION OF THE TERMS USED IN THE SPECIFICATION

The term ‘pre-determined domain’ used in this specification refers to domains such as sports, literature, leisure, food, entertainment and the like. Further, each of the pre-determined domains can also include sub-domains. For example, the domain ‘entertainment’ may further include sub-domains such as movies, television shows, live concerts, drama and the like.

### BACKGROUND

1. Technical Field

The embodiments herein relate to the field of behavioral tracking, and more particularly to selectively optimizing and customizing a promotional offer based on the behavior of an affinity group.

2. Description of the Related Art

Typically, an affinity group is a group comprising of a plurality of members. Typically, affinity groups are formed around a shared goal or interest. Examples of affinity groups include private social clubs, writing circles, reading circles, and hobby clubs. People typically join affinity groups in order to get a sense of belonging and networking. Upon maturity, affinity groups typically transform into centralized institutions that govern the behavior of the respective members, and also solicit funds from the members. In return for funding, the affinity groups provide the respective members with social benefits, goods, services, and the like. Further, in case of affinity groups, the sponsors (partners) of affinity groups sponsor the members with the intention of promoting their respective products or services. However, such sponsorship decisions are typically undertaken based on the (individual as well as collective) behavior of the members of the affinity group. Therefore, there was felt a need for a method and a system that would accurately analyze the behavior of an affinity group and accordingly optimize offers, typically promotional offers, in order to render them suitable for the affinity group.

### SUMMARY

A computer implemented system for selectively customizing the promotional offers to be made available to an affinity group, has been envisaged in accordance with a first embodiment herein. The system, in accordance with the first embodiment comprises a monitor configured to monitor the actions of the affinity group on a social networking portal, including the actions of the members of the affinity group.

The monitor is further configured to monitor the actions of the members of the affinity group, wherein the monitored actions are at least partially in response to previous promotional offers. The monitor is still further configured to actively monitor the location of each of the members of the affinity group.

The system further comprises a characterizer configured to characterize each of the members of the affinity group based on the monitored actions and the locations thereof. The characterizer is further configured to characterize the affinity group based on the actions and location of the individual members thereof. The characterizer is still further configured to characterize the affinity group in respect of at least one pre-determined domain.

The system, in accordance with the first embodiment further comprises an identifier having access to a plurality of promotional offers. The identifier is configured to identify at least one promotional offer matching the pre-determined domain(s) characterizing the affinity group.

The system, in accordance with the first embodiment further comprises a customizing module having access to the promotional offers identified by the identifier. The customizing module is configured to selectively customize the identified offer in order to render the identified offer suitable for the affinity group. The customization module is configured to customize the offer based on the monitored actions of the affinity group and the members thereof.

The system, in accordance with the first embodiment further comprises an offer generator configured to make the customized promotional offer(s) available to the affinity group.

The system, in accordance with the first embodiment further comprises an output unit providing the affinity group with electronic access to said at least one customized promotional offer.

The monitor, in accordance with the first embodiment is configured to monitor at least the acceptance of previous offerings, referral of previous offerings, redemption of previous offerings, frequency of receiving of previous offers, frequency of referring promotional offers, and expression of interest towards the promotional offerings.

In accordance with the first embodiment, the identifier is further configured to identify at least one promotional offer based on the minimum number of members required to be enrolled for the affinity group, and is further based on the value of the promotional offer.

In accordance with the first embodiment, the customizing module is further configured to selectively customize the identified promotional offer based on the minimum number of members required to be enrolled for the affinity group, and further based on the value of the promotional offer.

In accordance with the first embodiment, the affinity group comprises any of an organization, a religious organization, a school, a bank, a team, a company, a special interest group, an online community, an online social network community, and an insurance group.

A computer implemented method for selectively customizing the promotional offers to be made available to an affinity group is envisaged, in accordance with a second embodiment herein. The method, in accordance with the second embodiment comprises monitoring the actions of the affinity group on a social networking portal, including the actions of the members of the affinity group, wherein the actions are at least partially responsive to the previous promotional offers.

In accordance with the second embodiment, the method comprises monitoring the location of each of the members of the affinity group, characterizing each of the members of the affinity group based on the monitored actions and the locations thereof.

In accordance with the second embodiment, the method further comprises characterizing the affinity group based on the actions and location of the members thereof, and in respect of at least one pre-determined domain.

In accordance with the second embodiment, the method further comprises identifying at least one promotional offer matching the pre-determined domain(s) characterizing the affinity group; selectively customizing the identified offer based on the monitored actions of the affinity group and the members thereof, in order to render the identified offer suitable for the affinity group; and making available to the affinity group, the customized promotional offer(s), and providing electronic access to said affinity group of said at least one customized promotional offer.

In accordance with the second embodiment, the method further comprises providing electronic access to the affinity group of the at least one customized promotional offer.

In accordance with the second embodiment, monitoring the actions of the affinity group on a social networking portal, further includes monitoring at least the acceptance of previous offerings, referral of previous offerings, redemption of previous offerings, frequency of receiving of previous offers, frequency of referring promotional offers, and expression of interest towards the promotional offerings.

In accordance with the second embodiment, identifying at least one promotional offer further includes identifying at least one promotional offer based on the minimum number of members required to be enrolled for the affinity group, and further based on the value of the promotional offer.

In accordance with the second embodiment, selectively customizing the identified offer further includes selectively customizing the identified promotional offer based on the minimum number of members required to be enrolled for the affinity group, and based on the value of the promotional offer.

In accordance with a third embodiment, a non-transitory program storage device readable by computer, and comprising a program of instructions executable by the computer to perform a method for selectively customizing promotional offers to be made available to an affinity group, has been disclosed.

In accordance with the third embodiment, the method performed by the computer includes monitoring actions of the affinity group on a social networking portal, including actions of members of the affinity group, wherein the actions are at least partially responsive to previous promotional offers.

In accordance with the third embodiment, the method performed by the computer includes monitoring a location of each of the members of the affinity group.

In accordance with the third embodiment, the method performed by the computer includes characterizing each of the members of the affinity group based on the monitored actions and locations thereof, characterizing the affinity group based on the actions and locations of the members thereof, and in respect of at least one pre-determined domain.

In accordance with the third embodiment, the method performed by the computer includes identifying at least one promotional offer matching the at least one pre-determined domain characterizing the affinity group.

In accordance with the third embodiment, the method performed by the computer includes selectively customizing the identified offer based on the monitored actions of the affinity group and at least the locations of the members thereof in order to render the identified offer suitable for the affinity group.

In accordance with the third embodiment, the method performed by the computer includes making a customized promotional offer available to the affinity group.

In accordance with the third embodiment, the method performed by the computer includes providing electronic access to the affinity group of the at least one customized promotional offer.

In accordance with the third embodiment, monitoring the actions of the affinity group on a social networking portal further comprises monitoring at least one of an acceptance of previous offerings, referral of previous offerings, redemption of previous offerings, frequency of receiving of previous offers, frequency of referring promotional offers, and expression of interest towards the promotional offerings.

In accordance with the third embodiment, selectively customizing the identified promotional offer further comprises selectively customizing the identified promotional offer based on at least a minimum number of members required to be enrolled for the affinity group and a value of the promotional offer.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description, with reference to the drawings, in which:

FIG. 1 is a system level block diagram illustrating the functional blocks of the computer-implemented system for selectively customizing promotional offers, according to an embodiment disclosed herein;

FIG. 2 is a flow diagram illustrating the steps involved in a computer-implemented method for selectively customizing promotional offers, according to an embodiment disclosed herein; and

FIG. 3 illustrates a schematic diagram of a computer architecture used in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

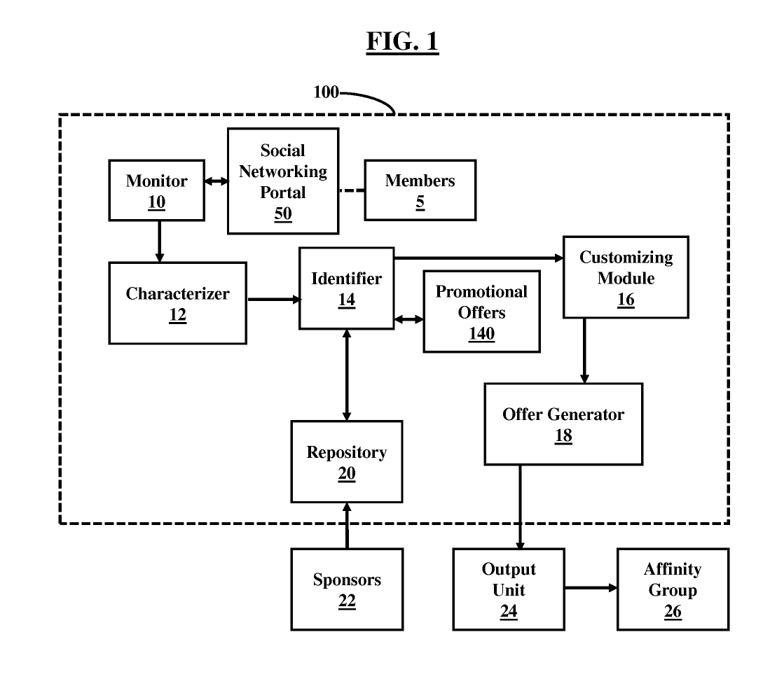

Referring now to the drawings, and more particularly to FIGS. 1 through 3, where similar reference characters denote corresponding features consistently throughout the figures, there are shown preferred embodiments. Customizing and optimizing an offer, typically a promotional offer, in order to render it suitable for an affinity group, can be a daunting task. By appropriately customizing a promotional offer, in accordance with the choices and preferences of the members of an affinity group, one can render the promotional offer effective, and can also ensure that the promotional offer appeals to a wider spectrum of members of an affinity group. Since the affinity group exhibits common traits and relatively similar patterns, in terms of the purchasing decisions made by the members thereof, accurately predicting the purchasing traits of the affinity group and accordingly customizing the promotional offers to be made available to the affinity group can enable an organization to improve upon its marketing efforts.

Moreover, since an affinity group's behavior is tracked in order to customize the existing promotional offers or to generate promotional offers suitable for the group, the process of behavior tracking requires it to be accurate. If proven otherwise, the inaccuracy of behavioral tracking could jeopardize the marketing efforts of the organization (making the promotional offers available).

The embodiments herein provide a computer implemented system and method for customizing the promotional offers to be made available to an affinity group. Referring to FIG. 1, there is shown a computer implemented system 100 for customizing the promotional offers to be made available to the member(s) 5 (referred to as user 5, hereafter) of an affinity group 26. The affinity group 26 can be an organization, a religious organization, a school, a bank, a team, a company, a special interest group, an online community, an online/offline social network, an insurance group and the like. In accordance with the embodiments herein, the affinity group 26 is preferably an online community which conducts its activities, inter-alia, through a social networking portal 50 (with which the members 5 of the affinity group 26 are affiliated).

The promotional offers are typically offered by sponsors 22 who represent organizations manufacturing products, providing services and combinations thereof. Further, an organization itself can be construed as a sponsor if it provides promotional offers (via its representatives). The sponsor 22 can be the manufacturer of a product/service desired by the user 5, or can be a third party interested in releasing the promotional offer to user 5. The promotional offer made available to the user 5 can be in respect of a service, a finished product, food product, or any item desirable to the user 5.

The promotional offers made available to the user 5 are redeemable at predetermined outlets/stores. The predetermined outlets/stores can be brick and mortar stores or online outlets. Typically, the promotional offers made available to user 5 by the sponsors 22 are made available to the user 5, through an online forum, such as a web site specifically designed for distributing promotional offers to the user 5. However, it is within the scope of the embodiments herein to distribute promotional offers through discount coupons, physical/online news letters, online/paper mails, and the like. Preferably, the promotional offers are disbursed (made available) to the user 5, through the social networking portal 50 through which the activities of the affinity group 26 are conducted. The disbursed promotional offers are typically directed to a product or a service (of one or more sponsors 22). The promotional offers can include a discount, a coupon, a voucher, an incentive to purchase, a ticket, an access pass, and any combination thereof.

In accordance with an embodiments herein the system 100 includes a monitor 10 that monitors the actions of the user 5 (and the other members of the affinity group 26) on the social networking portal 50 (preferably the social networking portal 50 through which the activities of the affinity group are conducted). The monitored actions of the user 5 include, but are not restricted to, acceptance of promotional offers, a referral of promotional offers, redemption of promotional offers, frequency of receiving promotional offers, frequency of referring promotional offers, a stated interest of promotional offers, a stated interest, and any combinations thereof. Further, the monitor 10 also monitors the locations of each of the member(s) (including user 5) of the affinity group. In accordance with this embodiment, the monitor 10 is further configured to monitor the behavior of the member(s) (including user 5) of the social networking portal. The behavior of the member(s) 5 is typically monitored and analyzed based on the actions of the member(s) 5.

Further, the system 100 further includes a characterizer 12 that characterizes the user 5 (and the other members of the affinity group 26). The characterizer 12, which may be configured as a hardware-enabled device comprising a processor(s) (not shown) for performing the functions thereof and/or for performing the steps directed to a retrievable software program, characterizes the user 5 based on the actions performed by the user 5 on the social networking portal 50. For example, if the user 5 receives a promotional offer from another member, or refers a promotional offer to another member, the characterizer 12 determines the domain associated with the promotional offer. For example, if the promotional offer is associated with a domain ‘A’, and if it is found (by the way of monitoring that the user 5 has received/referred a promotional offer belonging to the domain ‘A’, the user 5 is characterized as having an interest in domain ‘A’. The same process (of characterization in terms of predetermined domains) is undertaken for all the members of the social networking portal 50. The predetermined domains can include any category that may be relevant for marketing purposes, including demographic categories, socio-economic categories, and interests, such as sports, entertainment, science, home, garden, camping, education, college, and the like.

The characterization of the members (including user 5) of the social networking portal 50 enables the system 100 to identify the promotional offers highly relevant to the user 5. The characterization of the user 5 is updated and subject to change depending upon the (monitored) actions of the user 5. Further, the system 100 includes an identifier 14 configured to identify at least one promotional offer matching the predetermined domains. The identifier 14, which may be configured as a hardware-enabled device comprising a processor(s) (not shown) for performing the functions thereof and/or for performing the steps directed to a retrievable software program, preferably cooperates with a repository 20 digitally storing the promotional offers generated by the sponsors 22. The repository 20 may be configured as a database. Alternatively, the identifier 14 has direct access to a plurality of promotional offers 140. The identifier 14 identifies at least one promotional offer (generated by the sponsors) that corresponds to the predetermined domain with which user 5 is characterized (in this case the predetermined domain being ‘A’).

Further, the system 100 includes a customizing module 16 that selectively customizes the promotional offer(s) extracted by the identifier 14. The customizing module 16 may be configured as a hardware-enabled device comprising a processor(s) (not shown) for performing the functions thereof and/or for performing the steps directed to a retrievable software program. For example, if the user 5 is characterized with a predetermined domain ‘sports’, then the identifier 14 identifies only those offer(s) that fall under the domain ‘sports’. Further, the identifier 14 is configured to drill down to the individual actions performed by user 5, such as expressing interest in a pre activity energizer and recommending the same to a plurality of friends, and inviting his friends to share the energizer right before the commencement of the sport activity. Based on the aforementioned observations, the identifier 14 identifies promotional offers that are most appropriate for the user 5.

Further, the customizing module 16 customizes the promotional offer(s) identified by the identifier 14. Persisting with the same example of ‘sports’ domain, the customizing module 16 cooperates with the monitor 10 to access the monitored actions and behaviors of user 5. For example, within the ‘sports’ domain, user 5 could be found (based on monitoring of actions and behaviors, by the monitor 10) to prefer offers that relate to purchasing an energy drink before practicing a game rather than purchasing a meal at end of the sporting activity. Further, user 5 can be determined (based on monitoring of actions and behaviors, by the monitor 10) to have frequently purchased more than one serving of the energy drink prior to the practice session and to have purchased only a meal after the end of the sporting activity. Therefore, based on the aforementioned scenario, the customizing module 16 customizes the offer identified by the identifier 14, such that the promotional offer (identified by the identifier 14) preferably includes an offer that is directed towards an energy drink to be consumed before the practice rather than directing towards a meal discount voucher that could be redeemed at a sports bar/café.

The system 100 further includes an offer generator 18 configured to make the customized offer available (typically electronically) to the user 5. Typically, the offer generator 18, which may be configured as a hardware-enabled device comprising a processor(s) (not shown) for performing the functions thereof and/or for performing the steps directed to a retrievable software program, uploads the customized offer on the portal accessible to user 5, or on the social networking portal 50 account accessible to user 5. The portal or the social networking website 50 is typically accessible via an output unit 24.

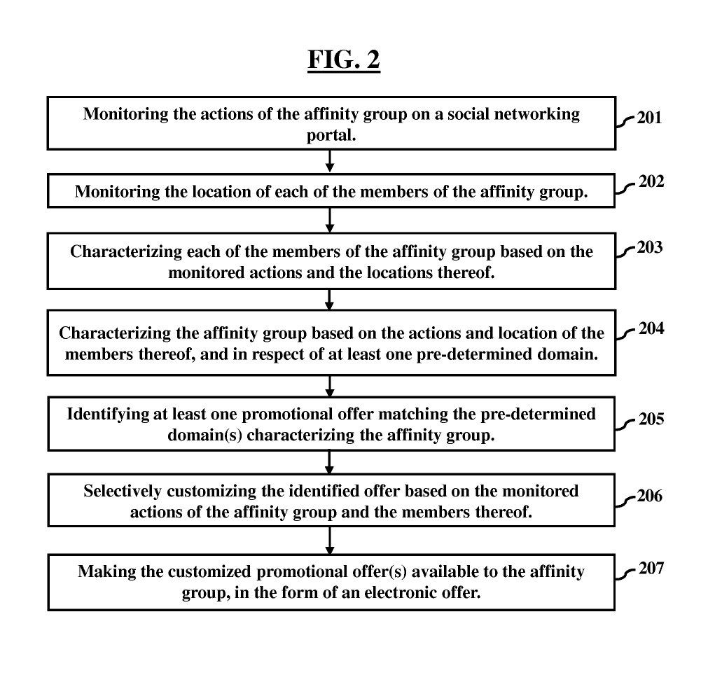

In accordance with a second embodiment herein, FIG. 2 illustrates a flow chart depicting the steps involved in the computer implemented method for customizing the promotional offers to be made available for the members of an affinity group. The method comprises monitoring (201) the actions of the affinity group on a social networking portal, including the actions of the members of the affinity group, wherein the actions are at least partially responsive to the previous promotional offers; monitoring (202) the location of each of the members of the affinity group; characterizing (203) each of the members of the affinity group based on the monitored actions and the locations thereof; characterizing (204) the affinity group based on the actions and location of the members thereof, and in respect of at least one pre-determined domain; identifying (205) at least one promotional offer matching the pre-determined domain(s) characterizing the affinity group; selectively customizing (206) the identified offer based on the monitored actions of the affinity group and the members thereof, in order to render the identified offer suitable for the affinity group; and providing (207) electronic access to the affinity group of the at least one customized promotional offer.

In accordance with the second embodiment, monitoring the actions of the affinity group on a social networking portal, further includes monitoring at least the acceptance of previous offerings, referral of previous offerings, redemption of previous offerings, frequency of receiving of previous offers, frequency of referring promotional offers, and expression of interest towards the promotional offerings.

In accordance with the second embodiment, identifying at least one promotional offer further includes identifying at least one promotional offer based on the minimum number of members required to be enrolled for the affinity group, and further based on the value of the promotional offer.

In accordance with the second embodiment, selectively customizing the identified offer further includes selectively customizing the identified promotional offer based on the minimum number of members required to be enrolled for the affinity group, and based on the value of the promotional offer.

The embodiments herein can include both hardware and software elements. The embodiments that are implemented in software include but are not limited to, firmware, resident software, microcode, etc. For example, the microcontroller can be configured to run software either stored locally or stored and run from a remote site.

In this regard, the software elements can be stored in the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

In accordance with a third embodiments herein, there is provided a non-transitory program storage device readable by computer, and comprising a program of instructions executable by the computer to perform a method for selectively customizing promotional offers to be made available to an affinity group.

In accordance with the third embodiment, the method performed by the computer includes monitoring actions of the affinity group on a social networking portal, including actions of members of the affinity group, wherein the actions are at least partially responsive to previous promotional offers.

In accordance with the third embodiment, the method performed by the computer includes monitoring a location of each of the members of the affinity group.

In accordance with the third embodiment, the method performed by the computer includes characterizing each of the members of the affinity group based on the monitored actions and locations thereof, characterizing the affinity group based on the actions and locations of the members thereof, and in respect of at least one pre-determined domain.

In accordance with the third embodiment, the method performed by the computer includes identifying at least one promotional offer matching the at least one pre-determined domain characterizing the affinity group.

In accordance with the third embodiment, the method performed by the computer includes selectively customizing the identified offer based on the monitored actions of the affinity group and at least the locations of the members thereof in order to render the identified offer suitable for the affinity group.

In accordance with the third embodiment, the method performed by the computer includes making a customized promotional offer available to the affinity group.

In accordance with the third embodiment, the method performed by the computer includes providing electronic access to the affinity group of the at least one customized promotional offer.

In accordance with the third embodiment, monitoring the actions of the affinity group on a social networking portal further comprises monitoring at least one of an acceptance of previous offerings, referral of previous offerings, redemption of previous offerings, frequency of receiving of previous offers, frequency of referring promotional offers, and expression of interest towards the promotional offerings.

In accordance with the third embodiment, selectively customizing the identified promotional offer further comprises selectively customizing the identified promotional offer based on at least a minimum number of members required to be enrolled for the affinity group and a value of the promotional offer.

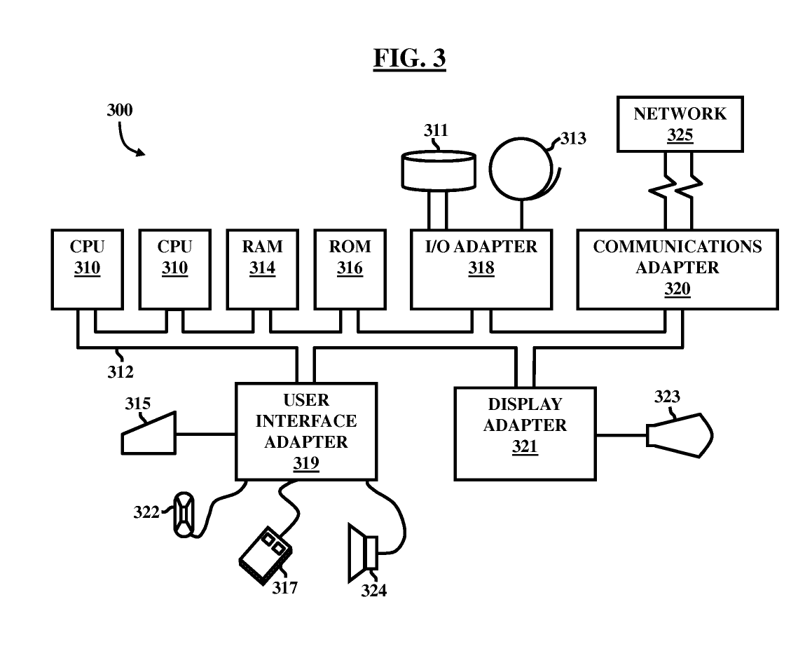

A representative hardware environment for practicing the software driven embodiments either locally or remotely is depicted in FIG. 3, with reference to FIGS. 1 through 2. This schematic drawing illustrates a hardware configuration of an information handling/computer system 300 in accordance with the embodiments herein. The system 300 comprises at least one processor or central processing unit (CPU) 310. The CPUs 310 are interconnected via system bus 312 to various devices such as a random access memory (RAM) 314, read-only memory (ROM) 316, and an input/output (I/O) adapter 318. The I/O adapter 318 can connect to peripheral devices 311, 313, or other program storage devices that are readable by the system 300. The system 300 can read the inventive instructions on the program storage devices and follow these instructions to execute the methodology of the embodiments herein. The system 300 further includes a user interface adapter 319 that connects a keyboard 315, mouse 317, speaker 324, microphone 322, and/or other user interface devices such as a touch screen device (not shown) to the bus 312 to gather user input. Additionally, a communication adapter 320 connects the bus 312 to a data processing network 325, and a display adapter 321 connects the bus 312 to a display device 323 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A computer implemented system for selectively customizing promotional offers to be made available to an affinity group, said system comprising:
a monitor that monitors actions of said affinity group on a social networking portal, including actions of members of said affinity group, wherein said actions are at least partially responsive to previous promotional offers offered to the members, said monitor further monitoring a location of each of said members of said affinity group;
a characterizer that characterizes each of said members of said affinity group based on the monitored actions and locations thereof, said characterizer further characterizing said affinity group based on said monitored actions and said location of said members thereof, said characterizer further characterizing said affinity group in respect of at least one pre-determined domain;
an identifier having access to a plurality of promotional offers, said identifier identifying at least one promotional offer matching said at least one pre-determined domain characterizing said affinity group;
a customizing module having access to said promotional offers identified by said identifier, said customizing module selectively customizing the identified offer in order to render said identified offer suitable for said affinity group, said customizing module further customizing the offer based on said monitored actions of said affinity group and at least said location of said members thereof;
an offer generator making at least one customized promotional offer available to said affinity group; and
an output unit providing said affinity group with electronic access to said at least one customized promotional offer.

2. The system as claimed in claim 1, wherein said monitor further monitors at least one of an acceptance of previous promotional offers, referral of said previous promotional offers, redemption of said previous promotional offers, frequency of receiving of said previous promotional offers, frequency of referring said previous promotional offers, and an expression of interest towards said previous promotional offers.

3. The system as claimed in claim 1, wherein said identifier identifies at least one promotional offer based on a minimum number of members required to be enrolled for said affinity group, and further based on a value of said promotional offer.

4. The system as claimed in claim 3, wherein said customizing module cooperates with said identifier to selectively customize the identified promotional offer based on said minimum number of members required to be enrolled for said affinity group, and further based on said value of said promotional offer.

5. The system as claimed in claim 1, wherein said affinity group comprises any of an organization, a religious organization, a school, a bank, a team, a company, a special interest group, an online community, an online social network community, and an insurance group.

6. A computer implemented method for selectively customizing promotional offers to be made available to an affinity group, said method comprising:
monitoring actions of said affinity group on a social networking portal, including actions of members of said affinity group, wherein said actions are at least partially responsive to previous promotional offers;
monitoring a location of each of said members of said affinity group;
characterizing each of said members of said affinity group based on the monitored actions and locations thereof, characterizing said affinity group based on the actions and locations of said members thereof, and in respect of at least one pre-determined domain;
identifying at least one promotional offer matching said at least one pre-determined domain characterizing said affinity group;
selectively customizing the identified offer based on said monitored actions of said affinity group and at least said locations of said members thereof in order to render said identified offer suitable for said affinity group;
making a customized promotional offer available to said affinity group; and
providing electronic access to said affinity group of said at least one customized promotional offer.

7. The method as claimed in claim 6, wherein monitoring the actions of said affinity group on a social networking portal further comprises monitoring at least one of an acceptance of previous offerings, referral of previous offerings, redemption of previous offerings, frequency of receiving of previous offers, frequency of referring promotional offers, and expression of interest towards the promotional offerings.

8. The method as claimed in claim 6, wherein identifying at least one promotional offer further comprises identifying at least one promotional offer based on a minimum number of members required to be enrolled for said affinity group, and further based on a value of said promotional offer.

9. The method as claimed in claim 6, wherein selectively customizing the identified promotional offer further comprises selectively customizing said identified promotional offer based on at least a minimum number of members required to be enrolled for said affinity group and a value of said promotional offer.

10. A non-transitory program storage device readable by computer, and comprising a program of instructions executable by said computer to perform a method for selectively customizing promotional offers to be made available to an affinity group, said method comprising:
monitoring actions of said affinity group on a social networking portal, including actions of members of said affinity group, wherein said actions are at least partially responsive to previous promotional offers;
monitoring a location of each of said members of said affinity group;
characterizing each of said members of said affinity group based on the monitored actions and locations thereof, characterizing said affinity group based on the actions and locations of said members thereof, and in respect of at least one pre-determined domain;
identifying at least one promotional offer matching said at least one pre-determined domain characterizing said affinity group;
selectively customizing the identified offer based on said monitored actions of said affinity group and at least said locations of said members thereof in order to render said identified offer suitable for said affinity group;
making a customized promotional offer available to said affinity group; and
providing electronic access to said affinity group of said at least one customized promotional offer.

11. The program storage device as claimed in claim 10, wherein monitoring the actions of said affinity group on a social networking portal further comprises monitoring at least one of an acceptance of previous offerings, referral of previous offerings, redemption of previous offerings, frequency of receiving of previous offers, frequency of referring promotional offers, and expression of interest towards the promotional offerings.

12. The program storage device as claimed in claim 11, wherein identifying at least one promotional offer further comprises identifying at least one promotional offer based on a minimum number of members required to be enrolled for said affinity group, and further based on a value of said promotional offer.

13. The program storage device as claimed in claim 11, wherein selectively customizing the identified promotional offer further comprises selectively customizing said identified promotional offer based on at least a minimum number of members required to be enrolled for said affinity group and a value of said promotional offer.
